(19) United States
(12) Patent Application Publication
(10) Pub. No.: US 2025/0013115 A1
(43) Pub. Date: Jan. 9, 2025

(54) ELECTROCHROMIC REARVIEW MIRROR ASSEMBLY

(71) Applicant: AimVEK Corporation., Hsinchu County (TW)

(72) Inventors: Ming-Chun CHIANG, Hsinchu County (TW); Yi-Chi CHENG, Hsinchu County (TW)

(21) Appl. No.: 18/649,375

(22) Filed: Apr. 29, 2024

(30) Foreign Application Priority Data
Jul. 5, 2023 (TW) 112125140

(51) Int. Cl. G02F 1/157; B60R 1/08; B60R 1/12; G02F 1/155; H04N 23/23

(52) U.S. Cl. CPC G02F 1/157; B60R 1/088; B60R 1/12; G02F 1/155; B60R 2001/1223; H04N 23/23

(57) ABSTRACT

An electrochromic rearview mirror assembly comprises a first substrate, a second substrate, an electrochromic medium, a light-transmitting conductive layer, a transflective film and a hiding perimeter layer. The first substrate includes a first surface and a second surface. The first surface comprises a first peripheral region and a first primary region. The second surface comprises a second peripheral region and a second primary region. The second substrate comprises a third surface and a fourth surface. The electrochromic medium is disposed between the first substrate and the second substrate. The light-transmitting conductive layer is disposed on the second primary region of the second surface. The transflective film is disposed on the third surface of the second substrate. The hiding perimeter layer is disposed on the second peripheral region of the second surface.

### CROSS-REFERENCE TO RELATED APPLICATION

The present application claims priority to Taiwan Patent App. No. 112125140, filed Jul. 5, 2023, the entirety of which are incorporated by reference herein

### FIELD OF THE INVENTION

The present invention relates to a rearview mirror assembly, in particular to an electrochromic rearview mirror assembly.

### BACKGROUND OF THE INVENTION

With diverse application requirements, vehicular rearview mirrors now serve beyond the traditional function of providing field of vision about cars approaching from behind or road conditions. They incorporate advanced features, such as electrochromic rearview mirrors equipped with ambient light sensors. These mirrors can detect the ambient light intensity and send a signal to control the electrochromic component, altering the light absorption properties of the electrochromic element. This, in turn, adjusts the reflectance of the vehicle's rearview mirror, effectively reducing glare and achieving a dimming effect.

Electrochromic rearview mirrors typically employ a transflective layer, which is a multi-layer film conventionally containing metallic materials. Examples of such mirrors are disclosed in U.S. patent Ser. No. 10/746,910B2, US Publication No. US20190094642A1, and U.S. Pat. No. 7,821,696B2, U.S. Pat. No. 7,663,798B2, U.S. Pat. No. 6,356,376B1, and others. The inclusion of metal in the transflective layer aims to give the mirror an aesthetically pleasing color and improved appearance, measured through parameters like color value or b* value. This results in a clear visual effect for observers looking at the electrochromic rearview mirror from the designated viewing direction, achieving a semi-reflection and semi-transmission effect.

The electrochromic rearview mirror may exhibit a subpar appearance if the multi-layer film on the transflective layer lacks metal materials. Consequently, the applicant contends that there is a need for improvement in existing electrochromic rearview mirrors.

### SUMMARY OF THE INVENTION

One aspect of the disclosure includes an electrochromic rearview mirror assembly, comprising a first substrate, a second substrate, an electrochromic medium, a light-transmitting conductive layer, a transflective film and a hiding perimeter layer. The first substrate comprises a first surface facing a viewer and a second surface behind the first surface, the first surface comprises a first peripheral region and a first primary region surrounded by the first peripheral region, the second surface comprises a second peripheral region and a second primary region surrounded by the second peripheral region. The second substrate is disposed behind the first substrate, the second substrate comprises a third surface facing the first substrate and a fourth surface opposite to the third surface. The electrochromic medium is disposed between the first substrate and the second substrate. The light-transmitting conductive layer is disposed on the second primary region of the second surface of the first substrate. The transflective film is disposed on the third surface of the second substrate, the transflective film faces the second primary region of the second surface of the first substrate. The hiding perimeter layer is disposed on the second peripheral region of the second surface of the first substrate. The transflective film is a metal-free multi-layer film, a b* value of the first peripheral region on the fabricated electrochromic rearview mirror assembly is between −2.6 and 0, and a b* value of the first primary region on the fabricated electrochromic rearview mirror assembly is between 0 and +2.5 when viewed from front of the electrochromic rearview mirror assembly.

Another aspect of the disclosure includes an electrochromic rearview mirror assembly, comprising a first substrate, a second substrate, an electrochromic medium, a light-transmitting conductive layer, a transflective film and a hiding perimeter layer. The first substrate comprises a first surface facing a viewer and a second surface opposite to the first surface, the first surface comprising a first peripheral region and a first primary region surrounded by the first peripheral region, the second surface comprising a second peripheral region and a second primary region surrounded by the second peripheral region. The second substrate is disposed behind the first substrate, the second substrate comprises a third surface facing the first substrate and a fourth surface opposite to the third surface. The electrochromic medium is disposed between the first substrate and the second substrate. The light-transmitting conductive layer is disposed on the second primary region of the second surface of the first substrate. The transflective film is disposed on the third surface of the second substrate, the transflective film is a metal-free multi-layer film and has a b* value between −5.7 and 0 prior to fabrication of the electrochromic rearview mirror assembly. The hiding perimeter layer is disposed on the second peripheral region of the second surface of the first substrate, the hiding perimeter layer has a b* value between −2.6 and 0 prior to fabrication of the electrochromic rearview mirror assembly.

Still another aspect of the disclosure includes an electrochromic rearview mirror assembly, comprising a first substrate, a second substrate, an electrochromic medium, a light-transmitting conductive layer, a transflective film and a hiding perimeter layer. The first substrate comprises a first surface facing a viewer and a second surface behind the first surface, the first surface comprises a first peripheral region and a first primary region surrounded by the first peripheral region, the second surface comprises a second peripheral region and a second primary region surrounded by the second peripheral region. The second substrate disposed is disposed behind the first substrate, the second substrate comprises a third surface facing to the first substrate and a fourth surface opposite to the third surface. The electrochromic medium is disposed between the first substrate and the second substrate. The light-transmitting conductive layer is disposed on the second primary region of the second surface of the first substrate. The transflective film is disposed on the third surface of the second substrate, the transflective film is a metal-free multi-layer film.

The hiding perimeter layer is disposed on the second peripheral region of the second surface of the first substrate. A b* value of the first primary region and a b* value of the first peripheral region of the first surface of the first substrate satisfy the following formula:

b₁*<b₂*

b₁* is the b* value of the first peripheral region, and b₂* is the b* value of the first primary region. A b* value of the transflective film and a b* value of the hiding perimeter layer satisfy the following formula:

b₄*<b₃*

b₃* is the b* value of the hiding perimeter layer prior to fabrication of the electrochromic rearview mirror assembly, and b₄* is the b* value of the transflective film. prior to fabrication of the electrochromic rearview mirror assembly.

### BRIEF DESCRIPTION OF THE DRAWINGS

FIG. 1 is a schematic cross-sectional view of the vehicular electrochromic rearview mirror assembly according to an embodiment of the present invention.

FIG. 2 is a schematic cross-sectional view of the vehicular electrochromic rearview mirror assembly according to another embodiment of the present invention.

FIG. 3 is a sectional view of a multilayer of the visible light transflective film according to an embodiment of the present invention.

FIG. 4 is a schematic front view of the vehicular electrochromic rearview mirror assembly according to an embodiment of the present invention.

### DETAILED DESCRIPTION OF THE PREFERRED EMBODIMENTS

It is to be understood that the terminology used in the description of the various embodiments and examples herein is for the purpose of describing particular examples only and is not intended to be limiting.

As used herein, the singular forms “a”, “an”, and “the” include the plural forms as well, unless the context clearly indicates otherwise, which do not denote a limitation of quantity, but rather denote the presence of at least one of the referenced item. In addition, the indefinite and definite articles shall include the plural and the singular unless the contrary is clear from the context.

As used herein, the terms “include” and “comprise” indicate the presence of recited features, ingredients, elements and/or compositions, but do not exclude the presence or addition of one or more other features, ingredients, elements, compositions and/or groups thereof.

As used herein, the terms “up”, “down”, “left”, “right”, “front”, “back” and their derivatives or synonyms, refer to the orientation of elements in the drawings and do not limit the invention unless the context clearly indicates otherwise.

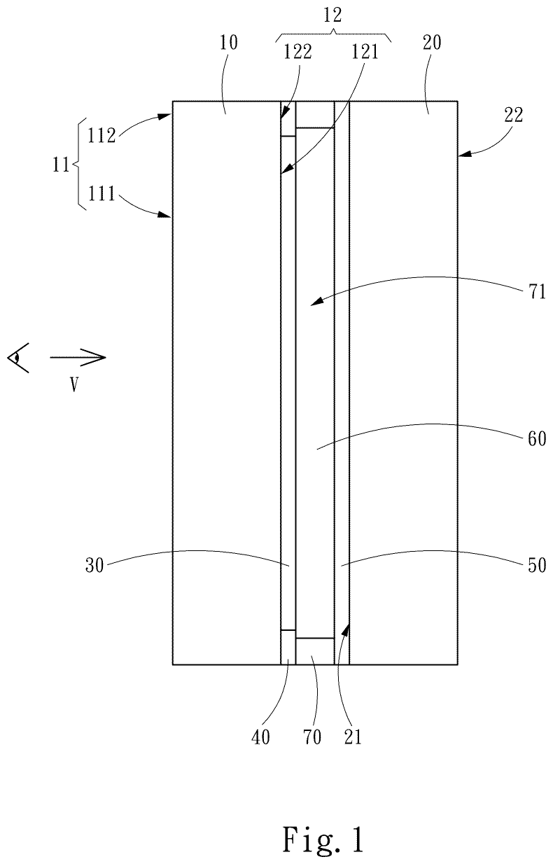

Referring now to the drawings and the illustrative embodiments depicted therein, a vehicular interior electrochromic rearview mirror assembly 1 in FIG. 1 comprises a first substrate 10, a second substrate 20, a light-transmitting conductive layer 30, a hiding perimeter layer 40, and a transflective film 50, an electrochromic medium 60 and a sealing member 70. The second substrate 20 is disposed behind the first substrate 10. The vehicular interior electrochromic rearview mirror assembly 1 may be adjustably mounted to an interior portion of a vehicle.

The first substrate 10 comprises a first surface 11 and a second surface 12. The first surface 11 faces an intended viewer. The second surface 12 is opposite to the first surface. The first surface 11 comprises a first primary region 111 and a first peripheral region 112. The second surface 12 comprises a second primary region 121 and a second peripheral region 122. The first primary region 111 is surrounded by the first peripheral region 112, and the second primary region 121 is surrounded by the second peripheral region 122. The primary region of the substrate may be defined as a central region that is viewable by an observer. The first primary region 111 is corresponding to the second primary region 121 in position and geometry, and the first peripheral region 112 is corresponding to the second peripheral region 122 in position and geometry. The first primary region 111 may define a visible window to the intended viewer, which provides variable transmission and variable reflection to the intended viewer.

The first substrate 10 and the second substrate 20 may be treated as a front component and a rear component, respectively. When observed from a front of the rearview mirror assembly 1 along a viewing direction V towards the first surface 11, the first peripheral region 112 and the second peripheral region 122 align with the hiding perimeter layer 40. The hiding perimeter layer 40 serves to conceal the sealing member 70 when viewed from the front of the rearview mirror assembly 1.

The second substrate 20 comprises a third surface 21 and a fourth surface 22. The third surface 21 faces toward the first substrate 10. The fourth surface 22 is disposed the opposite side to the third surface 21.

In an example, the first substrate 10 is made of an insulating material that is transparent to visible light and possesses ample strength to withstand the operational conditions of automobiles. The material may include glass, polymer, or plastic, with glass options such as borosilicate glass, soda lime glass, float glass, and similar varieties. The specifications for the second substrate 20 mirror those of the first substrate 10, except for the requirement that the second substrate 20 must be at least partially transparent to infrared light. The second substrate 20 may be made from glass, ceramic, polymer, or plastic.

The light-transmitting conductive layer 30 is disposed on the primary region 121 of the second surface 12 of the first substrate 10. The hiding perimeter layer 40 is disposed on the peripheral region 122 of the second surface 12 of the first substrate 10. The transflective film 50 is disposed on the third surface 21 of the second substrate 20.

The light-transmitting conductive layer 30 and the transflective film 50 serve as electrodes, respectively. The light-transmitting conductive layer 30 is made from a material having high light transmittance and excellent conductivity, examples of which include fluorine-doped tin oxides, doped zinc oxides, indium zinc oxides (Zn₃In₂O₆), indium tin oxides (ITO), and ITO/metal/ITO (IMI). The hiding perimeter layer 40 may be made from a metal material, such as a chromium layer.

The transflective film 50 has a near-infrared and/or an infrared light transmission level and a visible light reflectance level. In an example, the infrared light transmission level exceeds 50% and the visible light reflectance level exceeds 50%. In another example, the infrared light transmission level exceeds 60% and the visible light reflectance level exceeds 60%. In yet another example, the infrared light transmission level exceeds 70%.

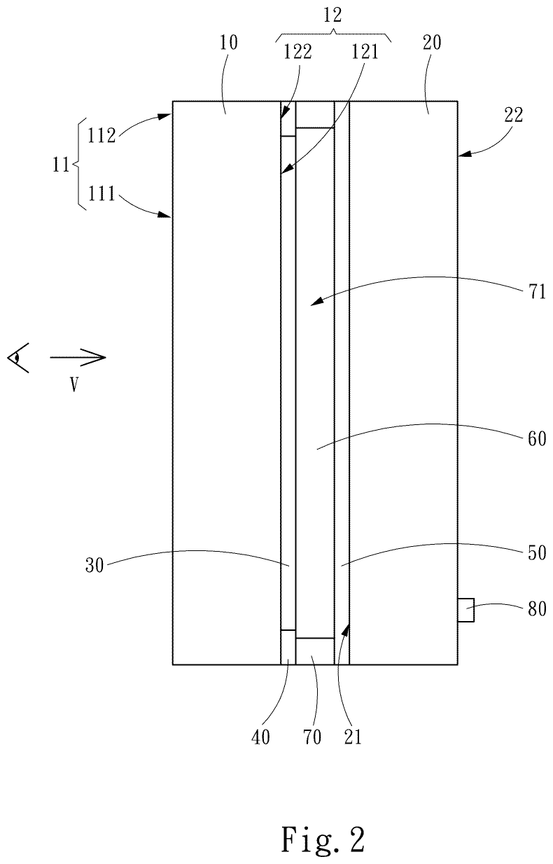

The transflective film 50 is configured as a multi-layer structure, specifically a metal-free multi-layer film. That is, there is no metal or alloy composition in the transflective film 50, thus reducing the cost of materials and also the complexity of manufacturing of the transflective film 50. The metal-free multi-layer film possesses optical characteristics that enable semi-reflection for visible light, high transmission for infrared light, and concurrent conductive properties. Hence, apart from functioning as an electrode, the transflective film 50 additionally furnishes the user with a rear view utilizing reflection through its optical attributes. Furthermore, the rearview mirror assembly 1 can be further equipped with an infrared thermal image sensor 80, as depicted in FIG. 2.

For instance, the infrared thermal image sensor 80 may be positioned on a side of the second substrate 20 opposite the first substrate 10, specifically, on the side opposite the viewing direction V. The infrared thermal image sensor 80 captures infrared rays passing through both the first substrate 10 and the second substrate 20 from the exterior, acquiring infrared thermal image data. This facilitates monitoring of conditions within the vehicle, thereby enhancing driver and passenger safety. For example, it may detect and identify scenarios such as driver drowsiness, intoxicated driving, unconsciousness, inadvertent locking of a child inside the vehicle, or leaving a child unattended in the vehicle. In the event of such occurrences, the vehicle can issue warnings to alert the driver, passengers, or third parties. In an example, the infrared thermal image sensor 80 is capable of sensing infrared light with a wavelength ranging between 940 nm and 1080 nm. The infrared thermal image sensor 80 may be connected to an electronic control unit (ECU) comprising a processor and a thermal imaging data obtained by the infrared thermal image sensor 80 is received at and is processed at the ECU.

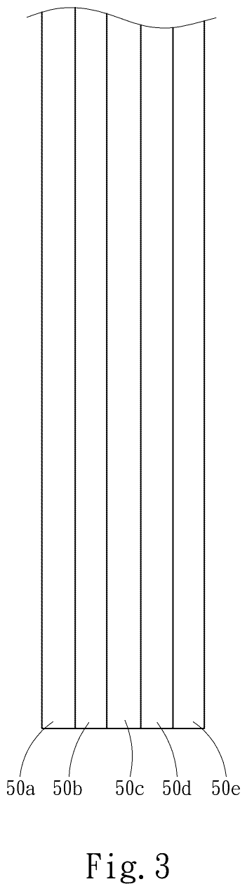

FIG. 3 provides a non-limiting example of the transflective film 50, which comprises a first layer 50a, a second layer 50b, a third layer 50c, a fourth layer 50d, and a fifth layer 50e, where the first layer 50a is ITO, the second layer 50b is SiO₂, the third layer 50c is Nb₂O₅, the fourth layer 50d is SiO₂, and the fifth layer 50e is a-Si, forming a five-layer structure of ITO/SiO₂/Nb₂O₂/SiO₂/a-Si. The first layer 50a is positioned close to a front of the rearview mirror assembly 1, while the fifth layer 50e is located close to a rear of the rearview mirror assembly 1. In an example, the first layer 50a has a thickness ranging between 100 nm and 200 nm, the second layer 50b has a thickness between 50 nm and 100 nm, the third layer 50c has a thickness between 25 nm and 75 nm, the fourth layer 50d has a thickness between 75 nm and 125 nm, and the fifth layer 50e has a thickness between 10 nm and 50 nm. In another example, the first layer 50a has a thickness of 155 nm, the second layer 50b has a thickness of 73 nm, the third layer 50c has a thickness of 56 nm, the fourth layer 50d has a thickness of 104 nm, and the fifth layer 50e has a thickness of 25 nm. Based on the above-mentioned configuration, the transflective film 50 has the infrared light transmission level exceeding 50% and the visible light reflectance level exceeding 50%. In an example, the transflective film 50 is composed of ITO, SiO₂, Nb₂O₅, SiO₂ and a-Si and without any metal composition.

The electrochromic medium 60 is positioned between the first substrate 10 and the second substrate 20. Moreover, the electrochromic medium 60 is situated between the light-transmitting conductive layer 30 and the transflective film 50. On each side of the electrochromic medium 60, direct contact is provided with the light-transmitting conductive layer 30 and the transflective film 50, respectively. The light-transmitting conductive layer 30 is a front electrode and the transflective film 50 is a back electrode, which are in electrical contact with the electrochromic medium 60 and electrically connected with an electrical circuit. By applying an electrical voltage or current to the electrochromic medium 60 through the light-transmitting conductive layer 30 and the transflective film 50, the color (hue) or tint of the electrochromic medium 60 can be altered.

The sealing member 70, the light-transmitting conductive layer 30 and the transflective film 50 collectively define a chamber 71 configured to house the electrochromic medium 60. The sealing member 70 serves the purpose of preventing any outward leakage of the electrochromic medium 60. In one example, epoxy resin can be utilized as the sealing member 70, and the hiding perimeter layer 40 functions to conceal the sealing member 70 in the viewing direction V.

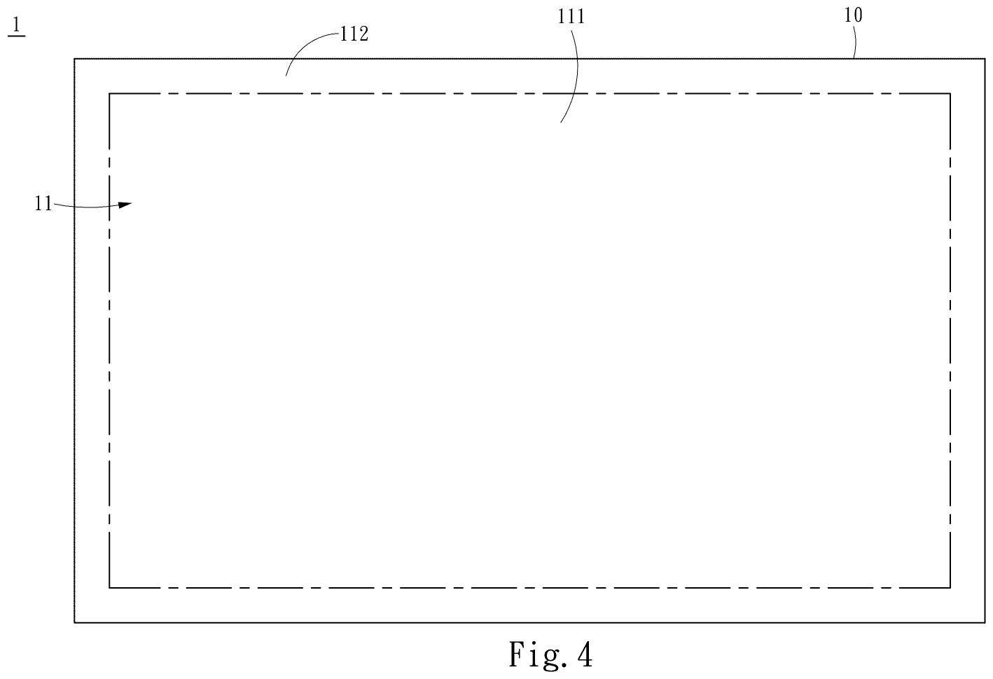

FIG. 4 illustrates the first primary region 111 and the first peripheral region 112 on the first surface 11. In an embodiment, the first substrate 10 and the light-transmitting conductive layer 30 are both substantially transparent, thus the color characteristics and reflectance effect presented in the first primary region 111 and the first peripheral region 112 are mainly influenced by the color characteristics and reflectance effect of the transflective film 50 and the hiding perimeter layer 40 situated behind these regions.

In discussing the color characteristics (a*, b*, C* and Y) of the electrochromic rearview mirror assembly 1, the b* values (b* in the CIELAB color space) of each of the elements in the electrochromic rearview mirror assembly 1 play a significant role in influencing the viewer's visual perception. A more positive b* value results in a yellower hue, while a more negative b* value produces a bluer hue. As the electrochromic rearview mirror assembly 1 is a stack structure of the first substrate 10, the second substrate 20, the light-transmitting conductive layer 30, the hiding perimeter layer 40, the transflective film 50 and the electrochromic medium 60. It should be understood that a b* value of the first primary region 111 and the first peripheral region 112 after the fabrication of the electrochromic rearview mirror assembly 1 is different from a b* value of the first primary region 111 and the first peripheral region 112 of the individually first substrate 10 prior to the fabrication. In other words, the individual b* value of the first substrate 10, the light-transmitting conductive layer 30, the hiding perimeter layer 40, the electrochromic medium 60 and the transflective film 50 together decide a b* value of the visible window. Namely, the b* value on the first primary region 111 and the first peripheral region 112 is influenced by the first substrate 10, the light-transmitting conductive layer 30, the hiding perimeter layer 40, the electrochromic medium 60 and the transflective film 50 positioned behind a front surface of the first substrate 10. However, the first substrate 10 and the light-transmitting conductive layer 30 usually are both substantially transparent, thus the color characteristics and reflectance effect of the first primary region 111 and the first peripheral region 112 are mainly influenced by the color characteristics and reflectance effect of the transflective film 50 and the hiding perimeter layer 40 situated behind these regions, when the electrochromic medium 60 is in a clear or a clearest states.

It is, therefore, important and crucial to coordinate the individual b* value of each of the elements (prior to fabrication) of the electrochromic rearview mirror assembly 1 within an appropriate range to ensure that the resultant b* value of the first primary region 111 and the first peripheral region 112 of the electrochromic rearview mirror assembly 1 (after fabrication) falls within a desired range to improve visual characteristics and minimize visually perceptible coloration, namely, minimizing color impact.

In addition to this, it is found that the contrast (or the difference) of the color characteristics between the b* values of the first primary region 111 and the first peripheral region 112 also plays a significant role in influencing the viewer's visual perception.

The b* values described below is measured in reflected ambient light and the electrochromic medium 60 is in a in a clear or a clearest state (no electrical potential difference between the electrodes.

In an example, viewed in the viewing direction V, the b* value of the first primary region 111 and the b* value of the first peripheral region 112 satisfy the following formula:

b₁*<b₂*

The b* value of the above formula is determined from a viewpoint of an observer (driver or vehicle occupant) looking at a front surface of the rearview mirror assembly 1, that is, when viewed in front of the rearview mirror assembly 1 (the fabricated assembly). b₁* is the b* value of the first peripheral region 112, and b₂* is the b* value of the first primary region 111.

The b* value of the individual transflective film 50 and the b* value of the individual hiding perimeter layer 40 satisfy the following formula:

b₄*<b₃*

In the above formula, b₃* is the b* value of the hiding perimeter layer 40 and b₄* is the b* value of the transflective film 50. b₃* and b₄* are the b* values associated with the individual transflective film and the individual hiding perimeter layer 40 prior to fabrication of the rearview mirror assembly 1.

In an example, the b₃* value of the hiding perimeter layer 40 is within the range between −2.6 and 0, such as between −2.6 and −2.2, and the b₄* value of the transflective film 50 is within the range between −5.7 and 0, such as between −5.7 and −5.1.

For the rearview mirror assembly 1 that is assembled from the hiding perimeter layer 40 with the b₃* value between −2.6 and 0 and the transflective film 50 with the b₄* value between −5.7 and 0, it is obtained that a resultant b* value of the first peripheral region 112 is between −2.6 and 0, and a resultant b* value of the first primary region 111 is between 0 and +2.5 when observed from the viewer toward the first surface 11 of the rearview mirror assembly 1. The resultant b* value is defined when the rearview mirror assembly 1 is in its clearest state without the applied voltage (no electrical potential difference between the electrodes).

For the rearview mirror assembly 1 that is assembled from the hiding perimeter layer 40 with the b₃* value between −2.6 and −2.2 and the transflective film 50 with the b₄* value between −5.7 and −5.1, it is obtained that a resultant b* value of the first peripheral region 112 is between −2.6 and −2.2, and a resultant b* value of the first primary region 111 is between +2.1 and +2.5 when observed from the viewer toward the first surface 11 of the rearview mirror assembly 1. The resultant b* value is defined when the rearview mirror assembly 1 is in its clearest state without the applied voltage (no electrical potential difference between the electrodes).

In an example, the resultant b* value of the first peripheral region 112 as viewed from the front of the rearview mirror assembly 1 is approximately −2.3, and the resultant b* value of the first primary region 111 as viewed from the front of the rearview mirror assembly 1 is approximately +2.4.

By carefully choosing the b* value of the transflective film 50 between −5.1 and −5.7, so that after the first substrate 10, the second substrate 20, the light-transmitting conductive layer 30, the transflective film 50 and the electrochromic medium 60 are stacked together, b* value of the first primary region 111 is between +2.1 and +2.5 and b* value of the first peripheral region 112 is between −2.6 and −2.2, providing improved visual characteristics and minimizing visually perceptible coloration.

What is claimed is:

1. An electrochromic rearview mirror assembly, comprising:
a first substrate, comprising a first surface facing a viewer and a second surface behind the first surface, the first surface comprising a first peripheral region and a first primary region surrounded by the first peripheral region, the second surface comprising a second peripheral region and a second primary region surrounded by the second peripheral region;
a second substrate disposed behind the first substrate, the second substrate comprising a third surface facing the first substrate and a fourth surface opposite to the third surface;
an electrochromic medium disposed between the first substrate and the second substrate;
a light-transmitting conductive layer disposed on the second primary region of the second surface of the first substrate;
a transflective film disposed on the third surface of the second substrate, the transflective film facing the second primary region of the second surface of the first substrate; and
a hiding perimeter layer disposed on the second peripheral region of the second surface of the first substrate;
wherein, the transflective film is a metal-free multi-layer film, a b* value of the first peripheral region on the electrochromic rearview mirror assembly is between −2.6 and 0, and a b* value of the first primary region on the electrochromic rearview mirror assembly is between 0 and +2.5 when viewed from front of the electrochromic rearview mirror assembly.

2. The electrochromic rearview mirror assembly according to claim 1, wherein the b* value of the first peripheral region when viewed from front of the electrochromic rearview mirror assembly is approximately −2.3.

3. The electrochromic rearview mirror assembly according to claim 1, wherein the b* value of the first primary region when viewed from front of the electrochromic rearview mirror assembly is approximately +2.4.

4. The electrochromic rearview mirror assembly according to claim 1, wherein the transflective film comprises a first layer, a second layer disposed on the first layer, a third layers disposed on the second layer, a fourth layer disposed on the third layer and a fifth layer disposed on the fourth layer, the first layer is indium tin oxide (ITO), the second layer is silicon dioxide (SiO₂), the third layer is niobium pentoxide (Nb₂O₅), the fourth layer is silicon dioxide (SiO₂), and the fifth layer is amorphous silicon (a-Si).

5. The electrochromic rearview mirror assembly according to claim 4, wherein a thickness of the first layer is between 100 nm and 200 nm, a thickness of the second layer is between 50 nm and 100 nm, a thickness of the third layer is between 25 nm and 75 nm, a thickness of the fourth layer is between 75 nm and 125 nm, and a thickness of the fifth layer is between 10 nm and 50 nm.

6. The electrochromic rearview mirror assembly according to claim 1, further comprising.

7. An electrochromic rearview mirror assembly, comprising:
a first substrate, comprising a first surface facing a viewer and a second surface behind the first surface, the first surface comprising a first peripheral region and a first primary region surrounded by the first peripheral region, the second surface comprising a second peripheral region and a second primary region surrounded by the second peripheral region;
a second substrate disposed behind the first substrate, the second substrate comprising a third surface facing the first substrate and a fourth surface opposite to the third surface;
an electrochromic medium disposed between the first substrate and the second substrate;
a light-transmitting conductive layer disposed on the second primary region of the second surface of the first substrate;
a transflective film disposed on the third surface of the second substrate, wherein the transflective film is a metal-free multi-layer film and has a b* value between −5.7 and 0 prior to fabrication of the electrochromic rearview mirror assembly; and
a hiding perimeter layer disposed on the second peripheral region of the second surface of the first substrate, the hiding perimeter layer having a b* value between −2.6 and 0 prior to fabrication of the electrochromic rearview mirror assembly.

8. The electrochromic rearview mirror assembly according to claim 7, wherein the b* value of the first peripheral region when viewed from front of the electrochromic rearview mirror assembly is between −2.6 and 0.

9. The electrochromic rearview mirror assembly according to claim 7, wherein the b* value of the first primary region when viewed from front of the electrochromic rearview mirror assembly is between 0 and +2.5.

10. The electrochromic rearview mirror assembly according to claim 7, wherein the transflective film comprises a first layer, a second layer disposed on the first layer, a third layers disposed on the second layer, a fourth layer disposed on the third layer and a fifth layer disposed on the fourth layer, the first layer is indium tin oxide (ITO), the second layer is silicon dioxide (SiO₂), the third layer is niobium pentoxide (Nb₂O₅), the fourth layer is silicon dioxide (SiO₂), and the fifth layer is amorphous silicon (a-Si).

11. The electrochromic rearview mirror assembly according to claim 10, wherein a thickness of the first layer is between 100 nm and 200 nm, a thickness of the second layer is between 50 nm and 100 nm, a thickness of the third layer is between 25 nm and 75 nm, a thickness of the fourth layer is between 75 nm and 125 nm, and a thickness of the fifth layer is between 10 nm and 50 nm.

12. The electrochromic rearview mirror assembly according to claim 7, further comprising an infrared thermal image sensor disposed on a side of the second substrate away from the first substrate, wherein the infrared thermal image sensor receives infrared rays transmit the first substrate and the second substrate from an outside to obtain an infrared thermal image data.

13. An electrochromic rearview mirror assembly, comprising:
a first substrate, comprising a first surface facing a viewer and a second surface behind the first surface, the first surface comprising a first peripheral region and a first primary region surrounded by the first peripheral region, the second surface comprising a second peripheral region and a second primary region surrounded by the second peripheral region;
a second substrate disposed behind the first substrate, the second substrate comprising a third surface facing to the first substrate and a fourth surface opposite to the third surface;
an electrochromic medium disposed between the first substrate and the second substrate;
a light-transmitting conductive layer disposed on the second primary region of the second surface of the first substrate;
a transflective film disposed on the third surface of the second substrate, the transflective film is a metal-free multi-layer film; and
a hiding perimeter layer disposed on the second peripheral region of the second surface of the first substrate;
wherein a b* value of the first primary region and a b* value of the first peripheral region of the first surface of the first substrate satisfy the following formula:
b₁*<b₂*
b₁* is the b* value of the first peripheral region, and b₂* is the b* value of the first primary region; and
wherein, a b* value of the transflective film and a b* value of the hiding perimeter layer satisfy the following formula:
b₄*<b₃*
b₃* is the b* value of the hiding perimeter layer prior to fabrication of the electrochromic rearview mirror assembly, and b₄* is the b* value of the transflective film. prior to fabrication of the electrochromic rearview mirror assembly.

14. The electrochromic rearview mirror assembly according to claim 13, wherein the transflective film comprises a first layer, a second layer disposed on the first layer, a third layers disposed on the second layer, a fourth layer disposed on the third layer and a fifth layer disposed on the fourth layer, the first layer is indium tin oxide (ITO), the second layer is silicon dioxide (SiO₂), the third layer is niobium pentoxide (Nb₂O₅), the fourth layer is silicon dioxide (SiO₂), and the fifth layer is amorphous silicon (a-Si).

15. The electrochromic rearview mirror assembly according to claim 14, wherein a thickness of the first layer is between 100 nm and 200 nm, a thickness of the second layer is between 50 nm and 100 nm, a thickness of the third layer is between 25 nm and 75 nm, a thickness of the fourth layer is between 75 nm and 125 nm, and a thickness of the fifth layer is between 10 nm and 50 nm.

16. The electrochromic rearview mirror assembly according to claim 13, further comprising an infrared thermal image sensor disposed on a side of the second substrate away from the first substrate, wherein the infrared thermal image sensor receives infrared rays transmit the first substrate and the second substrate from an outside to obtain an infrared thermal image data.
